(19) United States
(12) Patent Application Publication
(10) Pub. No.: US 2012/0090075 A1
(43) Pub. Date: Apr. 19, 2012

(54) CHEMICAL RESISTANT, MECHANICAL RESISTANT, ANTI-STATIC GLOVE

(76) Inventors: Andrea Barbara Piesker, Kuenzell (DE); Claudia Hansen, Gersfeld (DE)

(21) Appl. No.: 12/974,745

(22) Filed: Dec. 21, 2010

Related U.S. Application Data
(60) Provisional application No. 61/393,712, filed on Oct. 15, 2010.

(51) Int. Cl. A41D 19/00; B29C 41/14; A41D 19/04; H01B 1/12

(52) U.S. Cl. 2/168; 252/500; 264/299; 2/167

(57) ABSTRACT

A form-fitting glove having improved mechanical resistance, chemical permeation resistance, anti-static discharge (less than 1.0×10⁸ Ω vertical resistance at 23° C. and a relative humidity of 50%) and a method of manufacture are provided. The glove is either one layer or multi-layered and formed utilizing a standard latex dip line.

### CROSS REFERENCE TO RELATED APPLICATION

The present application claims priority and the benefit of U.S. Patent Application 61/393,712, filed Oct. 15, 2010, which is herein incorporated by reference.

### TECHNICAL FIELD

The present application pertains to chemical and mechanical resistant, anti-static gloves. More particularly, the present application relates to comfortable chemical and mechanical resistant gloves that have an anti-static discharge quality and are made by the use of a dip-line process.

### BACKGROUND

Although there are several types of chemical resistant gloves on the market that claim to be anti-static, most do not conform to any standard, such as that of requiring an electrical discharge/vertical resistance of less than 1.0×10⁸ Ω at a relative humidity of about 50% at 23° C. Also, many so-called anti-static gloves suffer the disadvantage of being cumbersome due to the presence of electrical lead wires and other metal attachments that disperse electrical charge.

Historically, in order to obtain the necessary chemical resistance, various membranes impervious to chemical agents were laminated or heat-sealed together to produce a chemical resistant glove, which then had metal wire or mesh attached to the glove to provide the electrostatic discharge. These types of gloves made hand movement difficult for the wearer. Therefore, there exists a need for a chemical resistant, anti-static glove that is comfortable.

### BRIEF DESCRIPTION OF THE DRAWINGS

In the drawings forming a portion of this disclosure:

FIG. 1 schematically demonstrates a glove that can be formed according to the present application; and

FIG. 2 is a depiction of an exemplary cross-section of the glove of FIG. 1.

### DETAILED DESCRIPTION OF THE EMBODIMENTS

While the application is susceptible of embodiment in many different forms, there are shown in the drawing and will be described herein in detail specific embodiments thereof with the understanding that the present disclosure is to be considered as an exemplification of the principles of the application and is not intended to limit the application to the specific embodiments illustrated.

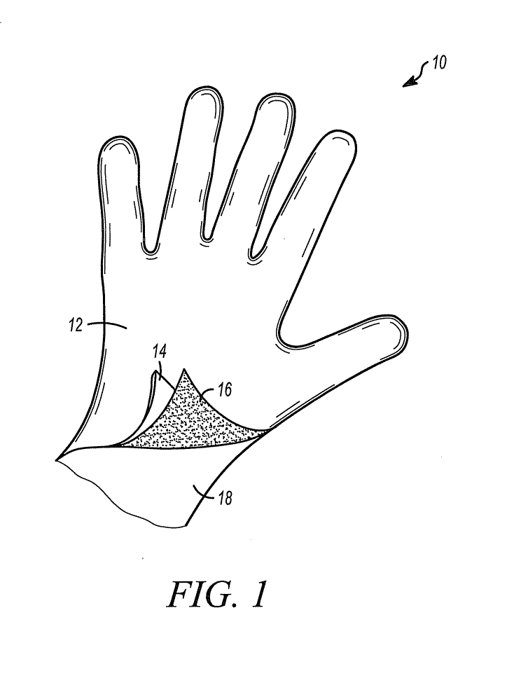

The present application relates to a skin-covering, which has improved resistance to chemical permeation and improved electrical discharge. The present application includes a method of forming such a skin-covering. The skin-covering can be a five-fingered glove, but it also can be a mitten having only a thumb or a mitten having any combination of fingers present from zero to five. (See FIG. 1) Such skin-covering is not limited to a glove or mitten, and can comprise an apron, coat, hat, scarf, shoe or sock.

The glove achieves a continuous discharge of electricity via the wearer's body so that spark formation and the danger of explosion is considerably less than that with an ordinary chemically protective glove. The chemical resistant and anti-static nature of the glove results from the presence of chemical resistant polymers and conducting polymers in the glove.

In one embodiment, the glove is comprised of one layer, which is a conducting polymer layer. The conducting polymer layer comprises a mixture of an anionic polymer and a chemical resistant polymer. The anionic polymer can be a polythiophene, such as poly(3,4-ethylenedioxythiophene)-poly(styrenesulfonate). Additionally, the anionic polymer can be an imidazolium salt. The anionic polymer is present in the conducting polymer layer at about 1 to about 70 percent by weight.

The chemical resistant polymer can be nitrile latex, chloroprene latex, natural latex, polyurethane, polyvinyl alcohol, butyl latex, fluoric latex, polyethylene or mixtures thereof. The chemical resistant polymer is present in the conducting polymer layer at about 50 to about 99 percent by weight. In another embodiment, the amount of chemical resistant polymer in the conducting polymer layer ranges from about 70% by weight to about 90% by weight. In yet another embodiment, the amount of chemical resistant polymer in the conducting polymer layer ranges from about 75% by weight to about 85% by weight.

In another embodiment, the conducting polymer layer comprises a mixture of poly(3,4-ethylenedioxythiophene)-poly(styrenesulfonate) and nitrile. In yet another embodiment, the conducting polymer layer comprises a mixture of about 1 to about 70% of an anionic polymer and about 50 to about 99% of a chemical resistant polymer. In yet another embodiment, the conducting polymer layer comprises a mixture of about 1 to about 70% poly(3,4-ethylenedioxythiophene)-poly(styrenesulfonate) and about 50 to about 99% nitrile.

The method can also encompass the addition of one or more additives wherein the additives comprise an adhesive, a defoamer, a thickener, a stabilizer, a colorant, an anti-microbial agent, fibers, a fragrance or mixtures thereof.

In still another embodiment, the glove is comprised of multiple layers. These multiple layers are comprised of at least one chemical resistant polymer layer and at least one conducting polymer layer. The chemical resistant polymer layer comprises a chemical resistant polymer including nitrile, chloroprene latex, natural latex, polyurethane, polyvinyl alcohol, butyl latex, fluoric latex, polyethylene or mixtures thereof. In one embodiment, the chemical resistant polymer comprises nitrile.

The conducting polymer layer of the glove comprises a mixture of an anionic polymer and a chemical resistant polymer. The anionic polymer is at least one of poly(3,4-ethylenedioxythiophene)-poly(styrenesulfonate) or an imidazolium salt. In one embodiment, the anionic polymer comprises poly(3,4-ethylenedioxythiophene)-poly(styrenesulfonate).

In one embodiment, the conducting polymer layer comprises a mixture of about 1 to about 70% an anionic polymer and about 50 to about 99% of a chemical resistant polymer. In another embodiment, the conducting polymer layer comprises about 1 to about 70 percent by weight poly(3,4-ethylenedioxythiophene)-poly(styrenesulfonate) and about 50 to about 99 percent by weight of nitrile latex.

The chemical resistant polymer layer can be a nitrile latex layer, although any material that imparts a chemical resistant nature to the glove is useful, such as chloroprene latex, natural latex, polyurethane, polyvinyl alcohol, butyl latex, fluoric latex, polyethylene or mixtures thereof.

The glove can further comprise one or more additives wherein the additives comprise an adhesive, a colorant, an anti-microbial agent, a fiber, a fragrance or mixtures thereof.

Optionally, the glove also comprises a donning layer, which lies next to the skin. The donning layer can be natural fibers, synthetic fibers, polyester, polyurethane, nitrile latex, chloroprene latex, polyvinyl alcohol, butyl latex, fluoric latex, or latex rubber. In one embodiment, the donning layer is a textile material, such as a flocked cotton liner.

It is to be understood that there is no set limitation as to the number of layers that the glove can have so long as the glove is comfortable and flexible enough for its intended use. There is also no limitation as to the presence of duplicate layers. There is no restriction as to the spatial arrangement of the layers.

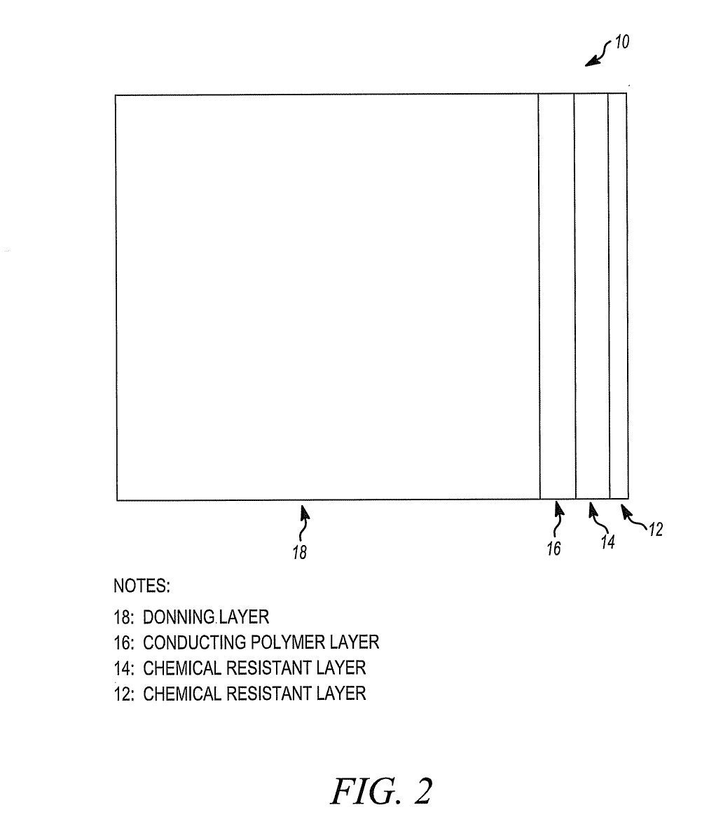

An embodiment of the glove (10) is made of multiple layers and is comprised of a donning layer (18) of cotton (flock liner) to be worn next to the skin, one conducting polymer layer (16) of a mixture of nitrile latex and poly(3,4-ethylenedioxythiophene)-poly(styrenesulfonate), and two chemical resistant polymer layers (12, 14) of nitrile for a total of four layers. (See FIG. 2)

The thickness of the layers ranges from about 0.01 mm to about 3 mm for each of the chemical resistant polymer layer and the conducting polymer layer. The thickness of the donning layer is in the range of about 0 mm to about 6 mm.

The present application also contemplates a method of forming a chemical resistant, anti-static glove. The chemical resistant and anionic polymer layers are included that can be dipped on standard latex type dip lines.

The method of forming a chemical resistant anti-static glove comprises dipping a hand-shaped former into a mixture of nitrile latex and poly(3,4-ethylenedioxythiophene)-poly(styrenesulfonate) so that a continuous layer of the mixture is deposited on the former, then removing the coated former from the mixture; dipping the coated former into nitrile latex so that a continuous layer of nitrile latex is deposited on the coated former and removing the former from the nitrile latex dipping solution; dipping the former into nitrile foam so that a continuous layer of nitrile foam is deposited on the former and removing the former from the nitrile foam dipping solution. The glove can then be stripped from the former. The paired dipping and removing steps can be independently repeated multiple times to form multiple layers, as desired. In addition, a donning layer can be added.

The method can also encompass the addition of one or more additives wherein the additives comprise an adhesive, a defoamer, a thickener, a stabilizer, a colorant, an anti-microbial agent, fibers, a fragrance or mixtures thereof.

From the foregoing, it will be observed that numerous variations and modifications may be effected without departing from the spirit and scope of the application. It is to be understood that no limitation with respect to the specific article and/or method illustrated herein is intended or should be inferred. It is, of course, intended to cover by the appended claims all such modifications as fall within the scope of the claims.

What is claimed:

1. A chemical resistant, anti-static glove comprising multiple layers of at least one chemical resistant polymer layer and at least one conducting polymer layer.

2. The glove of claim 1 wherein the chemical resistant polymer layer comprises a chemical resistant polymer including nitrile, chloroprene latex, natural latex, polyurethane, polyvinyl alcohol, butyl latex, fluoric latex, polyethylene or mixtures thereof.

3. The glove of claim 2 wherein the chemical resistant polymer comprises nitrile.

4. The glove of claim 1 wherein the conducting polymer layer comprises a mixture of an anionic polymer and a chemical resistant polymer.

5. The glove of claim 4 wherein the anionic polymer comprises at least one of poly(3,4-ethylenedioxythiophene)-poly(styrenesulfonate) or an imidazolium salt.

6. The glove of claim 4 wherein in the anionic polymer comprises poly(3,4-ethylenedioxythiophene)-poly(styrenesulfonate).

7. The glove of claim 1 wherein the conducting polymer layer comprises a mixture of about 1 to about 70% an anionic polymer and about 50 to about 99% of a chemical resistant polymer.

8. The glove of claim 1 wherein the conducting polymer layer comprises about 1 to about 70 percent by weight poly(3,4-ethylenedioxythiophene)-poly(styrenesulfonate) and about 50 to about 99 percent by weight of nitrile latex.

9. The glove of claim 1 further comprising a donning layer that includes at least one of cotton, polyester, polyurethane, natural fibers, synthetic fibers, nitrile latex, chloroprene latex, polyvinyl alcohol, butyl latex, fluoric latex, or latex rubber.

10. The glove of claim 1 further comprising one or more additives wherein the additives comprise an adhesive, a colorant, an anti-microbial agent, a fiber, a fragrance or mixtures thereof.

11. A chemical resistant anti-static glove comprising:
at least one layer of a mixture of nitrile and poly(3,4-ethylenedioxythiophene)-poly(styrenesulfonate);
at least one nitrile layer; and
at least one donning layer.

12. The glove of claim 11 wherein the donning layer comprises at least one layer of polyester, polyurethane, natural fibers, synthetic fibers, nitrile latex, chloroprene latex, polyvinyl alcohol, butyl latex, fluoric latex, latex rubber or mixtures thereof.

13. The glove of claim 11 wherein the layer of a mixture of nitrile and poly(3,4-ethylenedioxythiophene)-poly(styrenesulfonate) comprises about 1 to about 70 percent by weight poly(3,4-ethylenedioxythiophene)-poly(styrenesulfonate) and about 50 to about 99 percent by weight of nitrile.

14. The glove of claim 11 further comprising one or more additives wherein the additives comprise an adhesive, a colorant, an anti-microbial agent, a fiber, a fragrance or mixtures thereof.

15. A chemical resistant, anti-static glove comprising a conducting polymer layer comprised of a mixture of a chemical resistant polymer and an anionic polymer.

16. The chemical resistant, anti-static glove of claim 15 wherein the chemical resistant polymer comprises nitrile and the anionic polymer comprises poly(3,4-ethylenedioxythiophene)-poly(styrenesulfonate).

17. A method of forming a mechanical resistant, chemical resistant, anti-static glove comprising:
a) dipping a former into a mixture of nitrile latex and poly(3,4-ethylenedioxythiophene)-poly(styrenesulfonate) so that a continuous layer of the mixture is deposited on the former and removing the former from the mixture;
b) dipping the former into a nitrile solution so that a continuous layer of nitrile is deposited on the former and removing the former from the nitrile solution; and
c) dipping the former into a nitrile foam solution so that a continuous layer of nitrile foam is deposited on the former and removing the former from the nitrile foam solution to form a glove.

18. The method of claim 17 wherein the dipping and removing of a, b, and c, are each independently repeated multiple times to form multiple layers.

19. The method of claim 17 further comprising adding one or more additives wherein the additives comprise an adhesive, a colorant, an anti-microbial agent, a fiber, a fragrance or mixtures thereof.

20. The method of claim 17 further comprising adding a donning layer.
